(19) United States
(12) Patent Application Publication
(10) Pub. No.: US 2011/0091077 A1
(43) Pub. Date: Apr. 21, 2011

(54) DEVICE AND METHOD FOR PRODUCTION OF A LOCATION SIGNAL

(75) Inventor: Andre Puchert, Braunschweig (DE)

(73) Assignee: SIEMENS AKTIENGESELLSCHAFT, MUENCHEN (DE)

(21) Appl. No.: 12/997,637

(22) PCT Filed: Jun. 3, 2009
(86) PCT No.: PCT/EP2009/056815

§ 371 Date: Dec. 13, 2010

(30) Foreign Application Priority Data
Jun. 13, 2008 (DE) 10 2008 028 486.6

(51) Int. Cl. G06K 9/00

(52) U.S. Cl. 382/106

(57) ABSTRACT

A method generates a locating signal which indicates the location of a vehicle, in particular that of a track-bound vehicle. Accordingly, there is provision that a previously stored reference object in the surroundings of the vehicle is identified and the reference object is subjected to an intersection image or mixed image-distance measurement and the locating signal is generated by evaluating the intersection image or mixed image-distance measurement.

The invention relates to a method for production of a location signal, which indicates the location of a vehicle, in particular the location of a trackbound vehicle (for example a rail vehicle).

As is known, automatic train control devices such as ATO (ATO: Automatic Train Operation) devices can be used to control rail vehicles. In order to allow automatic train control, the respective position of the rail vehicle is determined continuously, and is used for train control.

Furthermore, the location of a rail vehicle must be determined relatively accurately when high-precision positioning of the rail vehicle is intended, for example at exit and entry points, for example in front of platform protection doors on a platform; this is because it is more difficult or impossible for passengers to enter and exit if the rail-vehicle doors are not opposite the platform protection doors.

Nowadays, crossed lines, laid in the track, of a conductor loop or location beacons in the form of beacons are used to determine the location of a rail vehicle, for example, generally in each case in conjunction with an odometer device on the rail vehicle. The trackside installation complexity in this case becomes greater the more accurate the positioning of the rail vehicle is intended to be, because the density of position reference points must become greater the more accurately the vehicle location is intended to be determined.

As is known, a relatively accurate location signal is required not only for the pure positioning of the rail vehicle but, furthermore, also when the aim is to monitor that the rail vehicle is safely stationary. Nowadays, components of the vehicle-side odometer are generally used to monitor the stationary state. The odometer sensor system may in this case consist, for example, of a combination of a position pulse transmitter and a Doppler radar. However, a Doppler radar has the disadvantage that, for physical reasons, it cannot detect a speed of less than 2 km/h, and is therefore suitable only to a very restricted extent for identification of the stationary state. A position pulse transmitter on its own is, however, generally not considered to be adequate for safety reasons; in general secondary or parallel systems are required, in order to ensure the safety of the overall system in the event of equipment failure.

Accordingly, the invention is based on the object to specify a method for production of a location signal. The aim is to allow the method to be carried out very easily, while nevertheless producing very accurate location signals.

According to the invention, this object is achieved by a method having the features as claimed in patent claim 1. Advantageous refinements of the method according to the invention are specified in dependent claims.

The invention therefore provides that a previously stored reference object is identified in the area around the vehicle, the reference object is subjected to a split-image or coincidence range measurement and the location signal is produced by evaluation of the split-image or coincidence range measurement.

One major advantage of the method according to the invention is that a location is determined on the basis of an optical measurement, thus allowing very high measurement accuracy to be achieved, with comparatively little measurement complexity. The method according to the invention also makes it possible to identify the stationary state, by monitoring rates of change of the location signal. In summary, because of the use, as intended according to the invention, of a split-image or coincidence range measurement, the method according to the invention allows the location of a vehicle and, associated with this, also identification of the stationary state, to be identified with very little complexity, but nevertheless with very good measurement results.

Preferably, two subimages of the reference object are produced in the course of the split-image or coincidence range measurement and are recorded by a camera and the reference object in the recorded subimages is subjected to the split-image or coincidence range measurement.

According to one particularly preferred refinement of the method, a range signal is produced as the location signal and indicates the range to the reference object, in that the distance to the reference object is first of all measured, forming a range measured value, in the course of the split-image or coincidence range measurement, and the range measured value is then output with the location signal.

Preferably, two subimages are produced by a split-image or coincidence range measurement device in the course of the split-image or coincidence range measurement, and the split-image or coincidence range measurement device is adjusted until the subimages fit together or coincidence of the subimages is found. The range measured value is then determined on the basis of the setting of the split-image or coincidence range measurement device for which the subimages fit together or are coincident.

The coincidence or the fitting together of the subimages can be found particularly quickly and easily, in the course of a digital image processing method, by a data processing device.

It is also considered to be advantageous for the split-image or coincidence range measurement device to be adjusted by the data processing device.

Another preferred refinement of the method provides that an output signal which indicates whether or not a predetermined range to the reference object is present is produced as the location signal, in that a split-image or coincidence range measurement device which has been preset to the predetermined range is used to check whether the subimages produced by the split-image or coincidence range measurement device are coincident or fit one another, and, if they are coincident or fit one another, a different output signal is produced than when the subimages are not coincident or do not fit.

By way of example, it is possible to use a data processing device to determine whether the subimages fit together or are coincident, in the course of a digital image processing method. A digital or binary signal is preferably produced as the output signal.

The invention also relates to a device for production of a location signal, which indicates the location of a vehicle, in particular that of a trackbound vehicle (for example a rail vehicle).

According to the invention, the following is provided for this purpose: a split-image or coincidence range measurement device, which produces two subimages of the area around the vehicle on the output side, a camera, which is arranged downstream from the split-image or coincidence range measurement device, for recording the subimages, and a data processing device which is connected to the camera and is designed such that it identifies a previously stored reference object in the recorded subimages in the course of image processing—for example, in the course of a digital image identification method—and produces the location signal by evaluation of the subimages of the reference object.

According to a first preferred refinement of the device, the data processing device is designed such that it produces a range signal as the location signal, which indicates the range to the reference object, in that it first of all measures the distance to the reference object, forming a range measured value, in the course of a split-image or coincidence range measurement, and outputs the respective range measured value with the location signal.

Preferably, the split-image or coincidence range measurement device has an adjustment device, which can be controlled and adjusted by the data processing device, wherein the data processing device is designed such that it adjusts the adjustment device until the subimages recorded by the camera fit one another or the subimages are found to be coincident, and determines the range measured value on the basis of the setting of the adjustment device when the subimages fit together or are coincident.

According to a second preferred refinement of the invention, the data processing device is designed such that it produces an output signal as the location signal, which indicates whether the reference object is or is not at a predetermined range, in that it uses the split-image or coincidence range measurement device, which has been preset to the predetermined range, to check whether the subimages recorded by the camera fit together or are coincident, and, if the subimages fit together or are coincident, produces a different binary output signal than when the subimages do not fit together or are not coincident.

The invention will be explained in more detail in the following text with reference to exemplary embodiments; in this case by way of example:

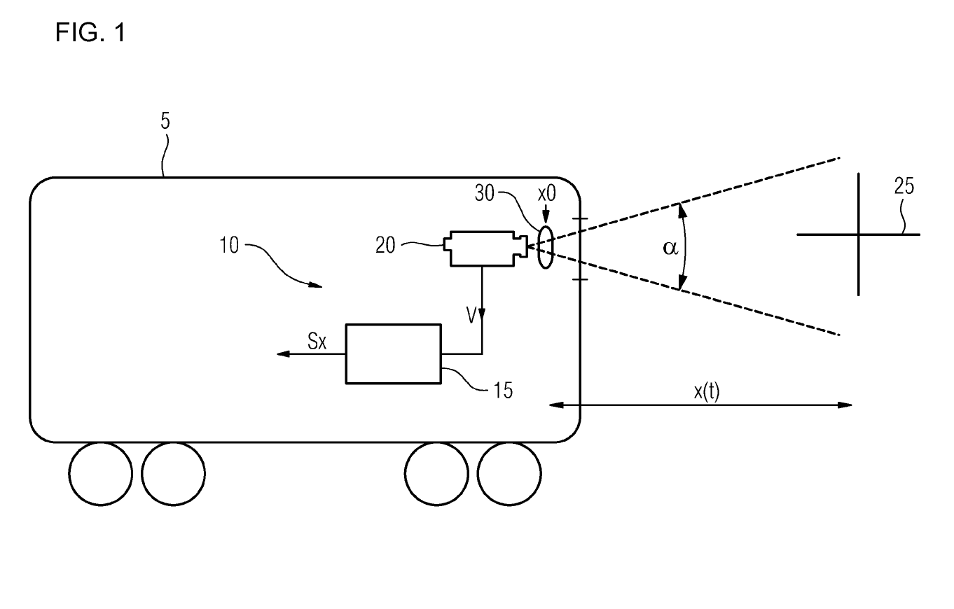

FIG. 1 shows a first exemplary embodiment of a device for production of a location signal,

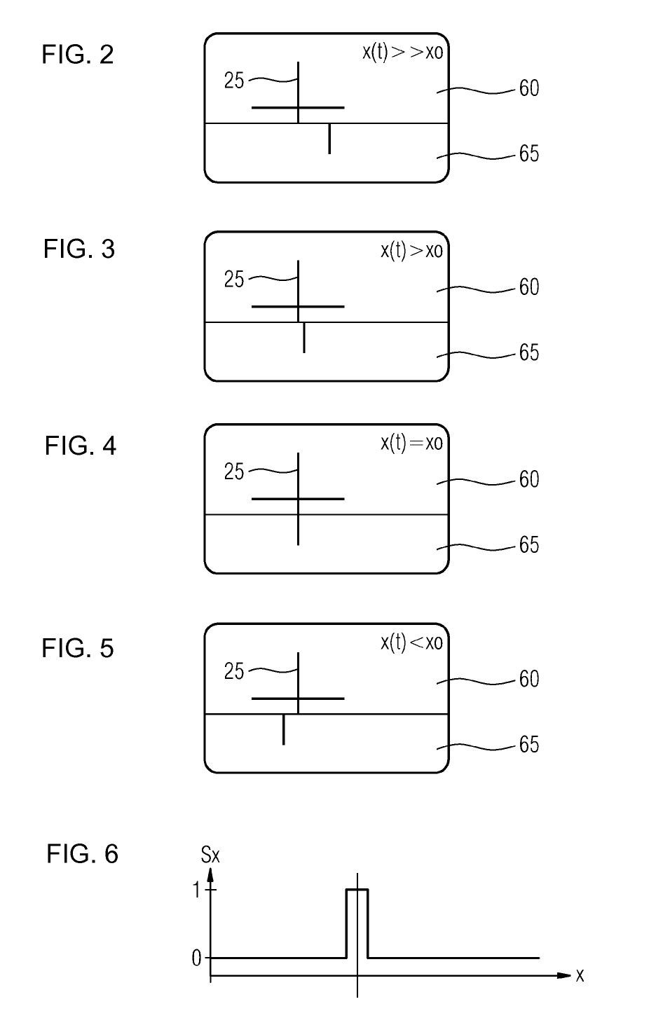

FIGS. 2 to 5 show exemplary embodiment of subimages which are produced by a camera in the device shown in FIG. 1,

FIG. 6 shows one exemplary embodiment of a binary output signal which can be produced by the device shown in FIG. 1,

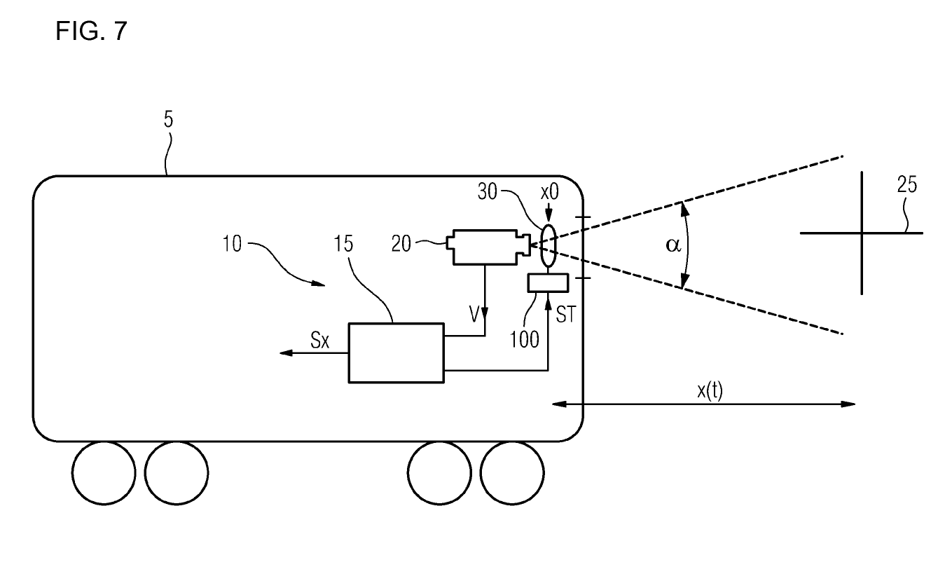

FIG. 7 shows a second exemplary embodiment of a device for production of a location signal,

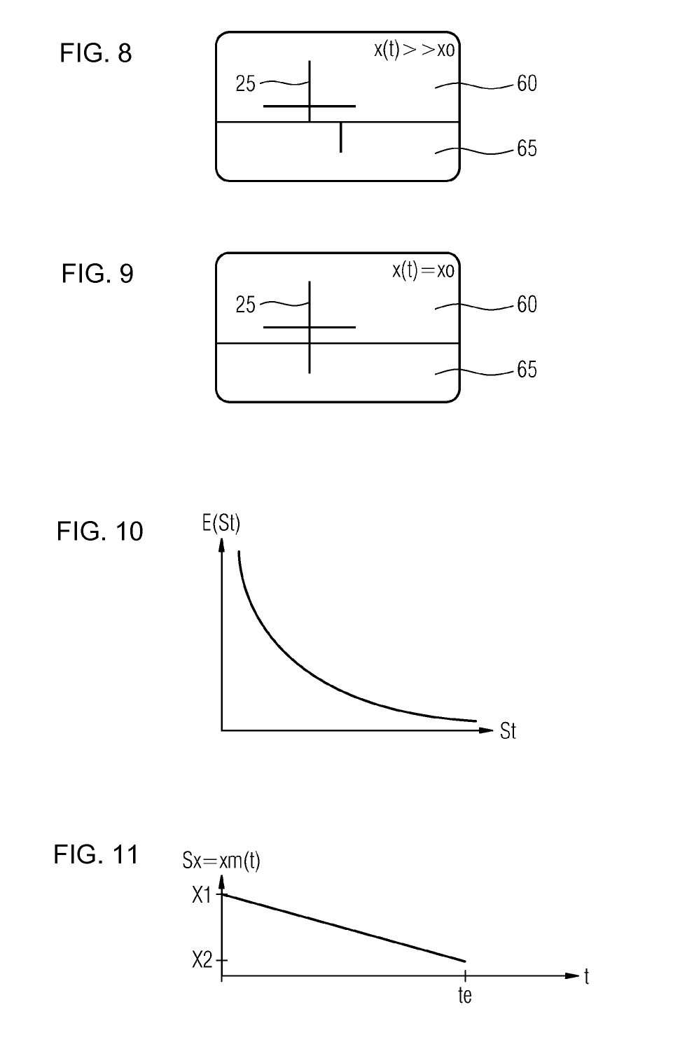

FIGS. 8 and 9 show exemplary embodiments of subimages which are produced by a camera in the device shown in FIG. 7,

FIG. 10 shows one exemplary embodiment of a calibration curve for production of a range measured value for the device shown in FIG. 7,

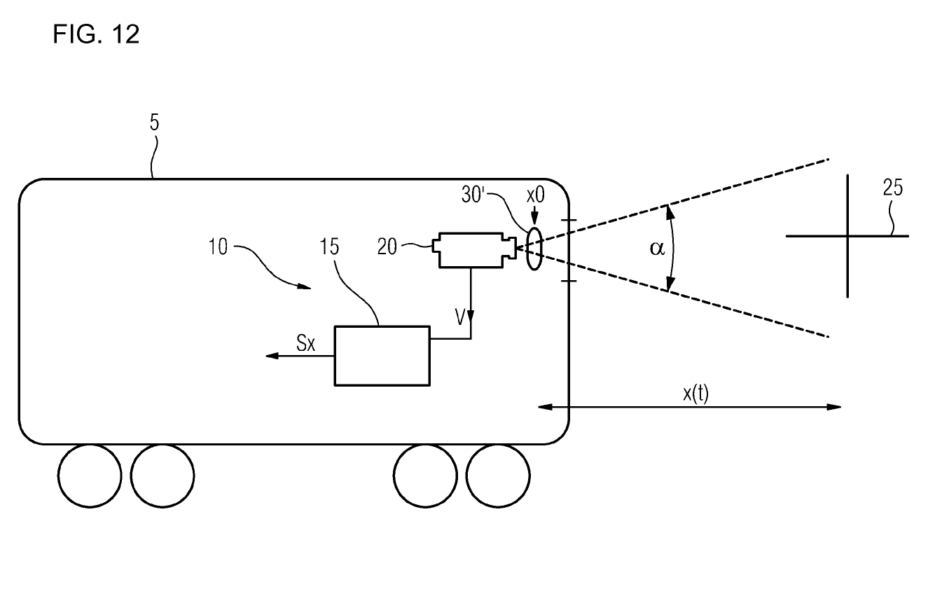

FIG. 11 shows one exemplary embodiment of a range measured value of the device shown in FIG. 7, in the form of a time profile,

FIG. 12 shows a third exemplary embodiment of a device for production of a location signal,

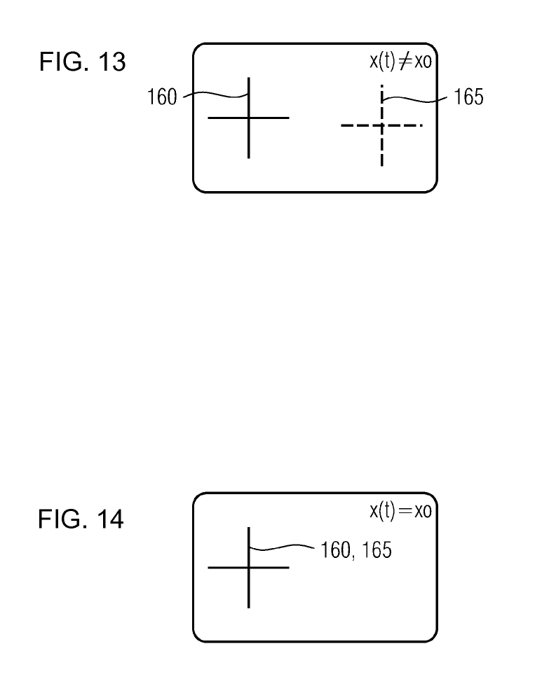

FIGS. 13 and 14 show exemplary embodiments of subimages which are produced by a camera in the device shown in FIG. 12,

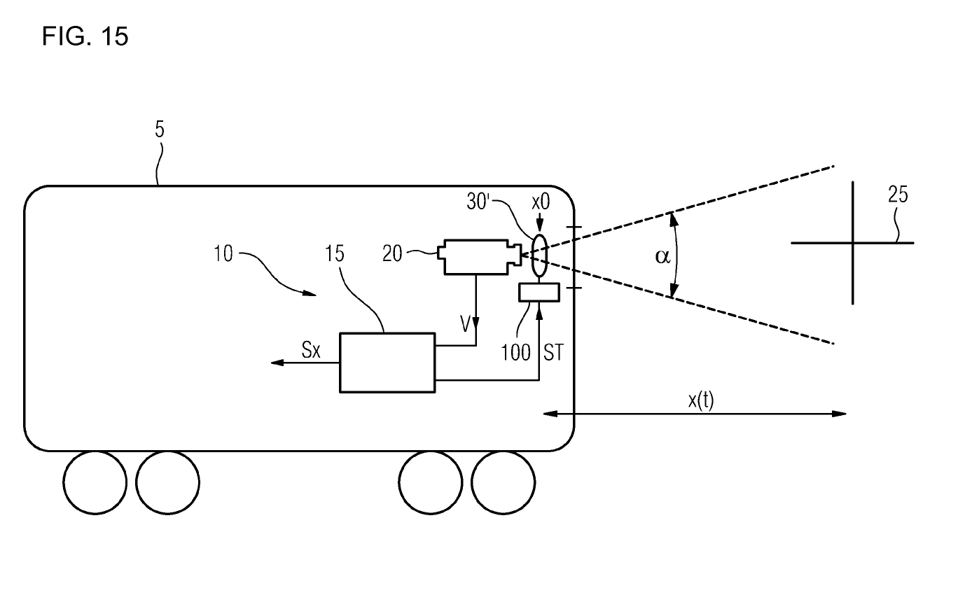

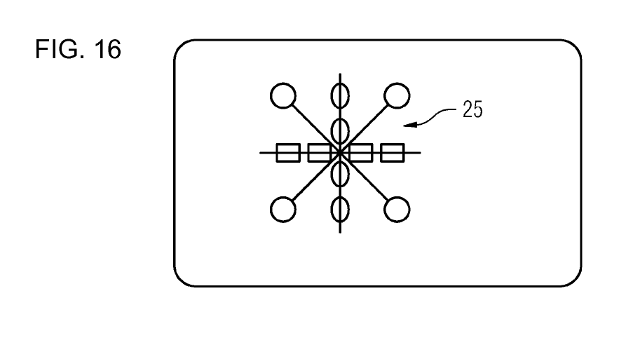

FIG. 15 shows a fourth exemplary embodiment of a device for production of a location signal, and

FIG. 16 shows a further exemplary embodiment of a reference object, on the basis of which the location signal can be produced.

For the sake of clarity, the same reference symbols are always used for identical or comparable components in the figures.

FIG. 1 illustrates a rail vehicle 5 which is equipped with a device 10 for production of a location signal Sx. The device 10 has a data processing device 15, to which a camera 20 is connected.

As can be seen from FIG. 1, the camera 20 is aligned with a reference object 25, which is fitted in a fixed position to the track, and whose position is known in advance. The viewing angle of the camera 20 is annotated by the viewing angle α in FIG. 1.

The camera 20 can be mounted fixed in the rail vehicle 5, such that the viewing angle α cannot change. Alternatively, it is also possible to equip the camera 20 with a zoom function, thus allowing the viewing angle α to be adjusted as required. It is also possible to fit the camera 20 on a mechanically adjustable holding apparatus such that it can be scanned or tilted, in order to allow the camera 20 to be aligned with any desired objects along the track on which the rail vehicle 5 is moving, preferably controlled by the data processing device 15. For the sake of clarity, FIG. 1 does not illustrate a mechanically adjustable holding apparatus such as this.

In the exemplary embodiment shown in FIG. 1, the reference object 25 is formed by a cross; other reference object shapes are, of course, also possible; for example, the reference object may also be a building or building parts, which the rail vehicle 5 enters or passes by. FIG. 16 shows a further exemplary embodiment of a suitable reference object 25; because of its unusual shape, this can be identified relatively easily in the course of a machine-assisted automatic image identification process, effectively in any given subimage of the split-image range measurement device 30.

As can also be seen from FIG. 1, a split-image range measurement device 30 is arranged between the camera 20 and the reference object 25. In the exemplary embodiment shown in FIG. 1, the setting of the split-image range measurement device 30 is predetermined and is fixed, and is permanently set to a predetermined distance value x0.

The distance between the rail vehicle 5 and the reference object 25 is annotated with the reference symbol x(t). By way of example, it is assumed that the rail vehicle is moving toward the reference object 25, as a result of which the distance x(t) to the reference object 25 is decreasing.

Since the split-image range measurement device 30 is arranged in front of the camera 20, the camera 20 will produce two subimages as the video signal V, and will pass these on to the data processing device 15.

FIG. 2 shows one exemplary embodiment for the subimages produced by the camera 20. The upper subimage in FIG. 2 is annotated with the reference symbol 60, and the lower subimage in FIG. 2 is annotated with the reference symbol 65.

As can be seen, the reference object 25 is not reproduced correctly, specifically because there is an offset between the two subimages 60 and 65. The exemplary embodiment shown in FIG. 2 is based on the assumption that the distance between the rail vehicle 5 and the reference object 25 is still very great. Therefore, x>>x0.

When the rail vehicle 5 now approaches the reference object 25, then the offset between the two subimages 60 and 65 relating to the reference object 25 decreases. This is illustrated, by way of example, in FIG. 3. As can be seen, the reference object 25 is already displayed virtually correctly.

As the rail vehicle 5 continues to approach the reference object 25, then the distance x(t) to the reference object 25 will correspond to the preset distance value x0 of the split-image range measurement device 30. Therefore, in this case, x(t)=x0. At this distance, the reference object 25 is displayed correctly in the video signal V produced by the camera 20 (cf. FIG. 4). As can be seen, the lower subimage 65 fits the upper subimage 60, and the reference object 25 is displayed without distortion.

When the rail vehicle 5 now moves even closer to the reference object 25, then the distance will become less than the predetermined distance value x0 of the split-image range measurement device 30. A shifted image will then be produced again for values x<x0, as is illustrated by way of example in FIG. 5. The two subimages 60 and 65 no longer fit one another, as a result of which the reference object 25 is displayed falsely.

The video signal V produced by the camera 20 is evaluated by the data processing device 15, which first of all reidentifies the reference object 25 in the video signal V, with this reference object 25 having previously been stored in the data processing device.

The data processing device 15 will then use the upper subimage 60 and the lower subimage 65 to check whether the reference object 25 produced in the video signal V completely matches the stored reference object, and is not distorted.

If this is the case, as is illustrated in FIG. 4, then the data processing device 15 will produce a binary output signal as the location signal Sx. By way of example, the binary output signal may be a logic 1 when the distance x(t) corresponds to the predetermined distance value x0 nd the subimages match one another. In contrast, if the distance x(t) to the reference object 25 does not correspond to the predetermined distance value x0 and the two subimages do not fit together, then a binary output signal at a logic 0 is produced as the location signal Sx. As already explained, the reference object 25 is represented falsely in the illustrations shown in FIGS. 2, 3 and 5, as a result of which a logic 0 will be produced as the binary output signal in this case (cf. FIG. 6).

By way of example, the binary output signal Sx may be used to supply a location signal to an automatic train control system, such as an ATO device, in order to allow the train control system to operate correctly. In addition to being used for pure location purposes, the device 10 may, however, also be used to identify the stationary state. For example, if the rail vehicle 5 is positioned at a stop at a distance x(t) from the reference object 25 which corresponds to the predetermined distance value x0, then the data processing device 15 can check whether the rail vehicle 5 is actually stationary. If the rail vehicle 5 is not moving, the location signal Sx will be a logic 1. When the location signal changes from a logic 1 to a logic 0, then the rail vehicle 5 must have moved, such that it is either at a greater distance or a lesser distance from the reference object 25.

FIG. 7 shows a second exemplary embodiment for a rail vehicle 5 having a device 10 for production of a location signal Sx. In contrast to the exemplary embodiment shown in FIG. 1, the split-image range measurement device 30 additionally has an adjustment device 100 by means of which the predetermined distance value x0 of the split-image range measurement device 30 can be adjusted, controlled by a control signal ST. In contrast to the exemplary embodiment shown in FIG. 1, it is therefore possible to set coincidence between the upper subimage 60 and the lower subimage 65 for the reference object 25 for any distance x(t) between the rail vehicle 5 and the reference object 25.

By way of example, if the data processing device 15 finds that the upper subimage 60 does not fit the lower subimage 65 or there is no coincidence (cf. FIG. 8), then it will produce a control signal ST, by means of which the predetermined distance value x0 of the split-image range measurement device 30 is adjusted such that the two subimages 60 and 65 fit together for the reference object 25, and there is coincidence with respect to the connecting points. This is illustrated, by way of example, in FIG. 9. After the two subimages 60 and 65 have been made to coincide or have been moved such that they fit, the data processing device 15 uses the control signal ST, which is output for adjustment of the adjustment device 100, to determine the range between the rail vehicle 5 and the reference object 25.

By way of example, it can use a comparison curve or calibration curve for this purpose, as is illustrated in FIG. 10. FIG. 10 shows a graph indicating the range setting of the split-image range measurement device 30 as a function of the respectively applied control signal ST. The range setting is annotated with the reference symbol E(ST).

By reading the calibration curve as shown in FIG. 10, the data processing device 15 determines the respective distance x(t) between the rail vehicle 5 and the reference object 25, and outputs a range measured value xm(t) as the location signal Sx. The range measured value xm(t) therefore indicates the respective distance between the rail vehicle 5 and the reference object 25. By way of example, FIG. 11 shows a profile for the range measured value xm(t). As can be seen, the rail vehicle 5 is moving toward the reference object 25, specifically because the measured distance between the rail vehicle 5 and the reference object 25 is decreasing.

Furthermore, it can be seen that, at the time te, the measurement is ended and a range measured value is no longer output. By way of example, this can occur when the rail vehicle 5 has moved past the reference object 25, and/or the reference object 25 is no longer within the viewing angle a of the camera 20.

The reference object 25 can be prevented from sliding or moving out of the viewing angle a, or this can be delayed, by the viewing angle a of the camera 20 being adjustable, as has already been mentioned in the introduction.

FIG. 12 shows a third exemplary embodiment of a rail vehicle 5 having a device 10 for production of a location signal Sx. Instead of a split-image range measurement device 30, the device 10 has a coincidence range measurement device 30′, which is preset to be fixed to a fixed predetermined distance value x0.

In contrast to the split-image range measurement device 30 shown in FIGS. 1 and 7, the coincidence range measurement device 30′ shown in FIG. 12 does not output separate subimages which are located physically alongside one another and are made to fit or to be coincident at their interface, but instead of this, outputs two subimages which are located one on top of the other. The video signal V produced by the camera 20 therefore produces two subimages of the reference object 25, which are annotated with the reference symbols 160 and 165 in FIGS. 13 and 14.

By way of example, FIG. 13 shows subimages 160 and 165 which are not coincident. The lack of coincidence between the two subimages 160 and 165 makes it possible to tell that the distance between the rail vehicle 5 and the reference object 25 does not correspond to the predetermined distance value x0, which is predetermined for the coincidence range measurement device 30′.

The distance between the rail vehicle 5 and the reference object 25 corresponds to the predetermined distance value x0 only when the two subimages 160 and 165 are coincident, for example as is shown in FIG. 14.

In summary, the method of operation of the coincidence range measurement device 30′ as shown in FIG. 12 corresponds substantially to the method of operation of the split-image range measurement device 30 as shown in FIG. 1, since both devices operate using a predetermined distance value x0. The coincidence range measurement device 30′ can accordingly output a binary output signal S as the location signal Sx, as has already been explained in conjunction with FIG. 6.

FIG. 15 shows a further exemplary embodiment for a rail vehicle 5 having a device 10 for production of a location signal Sx. This exemplary embodiment has a coincidence range measurement device 30′ which is also equipped with an adjustment device 100. The adjustment device 100 is connected to the data processing device 15, and is controlled by it via a control signal ST.

As already explained, the coincidence range measurement device 30′ produces two subimages 160 and 165 of the reference object 25, which are or are not coincident depending on the distance value x0 predetermined for the coincidence range measurement device 30′. When the data processing device 15 now finds that the two subimages 160 and 165 are not coincident, as is shown in FIG. 13, then it will use the control signal ST and the adjustment device 100 to vary the predetermined distance value x0 of the coincidence range measurement device 30′ until coincidence is achieved. Such coincidence is shown, as already explained, in FIG. 14.

The data processing device 15 will then use the calibration curve as shown in FIG. 10 to determine what range setting E(ST) corresponds to the respective control signal ST, and will use the determined range setting of the adjustment device 100 and of the coincidence range measurement device 30′ to determine what the current distance x(t) is between the rail vehicle 5 and the reference object 25. The corresponding range measured value xm(t) is output as the location signal Sx. By way of example, when measuring the distance x(t), a range signal Sx can be recorded, as is shown in FIG. 11.

The above exemplary embodiments have been used to explain how a location signal Sx can be produced, either in the form of a range measured value xm(t) (cf. FIG. 11) or in the form of a binary signal (cf. FIG. 6). The location signal Sx can furthermore be used to identify that the vehicle is stationary, by observing and/or recording the time profile and, possibly, a rate of change of the location signal Sx, and by evaluating this. For example, it can always be deduced that the vehicle is moving, if the location signal is changing. In many cases, however, it is advantageous to allow a certain tolerance for the location signal Sx and a certain rate of change of the location signal Sx, that is to say for example a certain fluctuation or drifting of the location signal Sx without directly or immediately deducing that the vehicle is moving impermissibly. In order to allow such an assessment and tolerance, it is considered to be advantageous to subject the location signal Sx to filtering, for example to digital or numerical filtering (for example in the data processing device 15), and to evaluate the filtered location signal to determine whether the vehicle is stationary. In other words, it is considered to be advantageous to use a (for example digitally) filtered location signal to produce a stationary identification signal.

1-13. (canceled)

14. A method for producing a location signal, which indicates a location of a vehicle, including a track bound vehicle, which comprises the steps of:
identifying a previously stored reference object in an area around the vehicle;
subjecting a reference object to a range measurement selected from the group consisting a split-image range measurement and a coincidence range measurement; and
producing the location signal by evaluation of the range measurement.

15. The method according to claim 14, which further comprises:
producing two subimages of the reference object in a course of the range measurement and are recorded by a camera resulting in recorded subimages; and
subjecting the reference object in the recorded subimages to the range measurement.

16. The method according to claim 14, which further comprises:
producing a range signal as the location signal and the range signal indicates a range to the reference object;
measuring a distance to the reference object;
forming a range measured value, in a course of the range measurement; and
output the range measured value with the location signal.

17. The method according to claim 16, which further comprises:
producing two subimages by a range measurement device selected from the group consisting of a split-image range measurement device and a coincidence range measurement device in a course of the range measurement, and the range measurement device is adjusted until the subimages fit together or a coincidence of the subimages is found; and
determining the range measured value on a basis of a setting of the range measurement device for which the subimages fit together or are coincident.

18. The method according to claim 17, wherein the subimages fitting together or being coincident is found by a data processing device in a course of a digital image processing method.

19. The method according to claim 17, which further comprises adjusting the range measurement device via a data processing device.

20. The method according to claim 14, which further comprises:
producing an output signal which indicates whether or not a predetermined range to the reference object is present as the location signal;
using a range measurement device selected from the group consisting of a split-image range measurement device and a coincidence range measurement device which has been preset to the predetermined range to check whether subimages produced by the range measurement device fit together or the subimages are coincident; and
if the subimages fit together or are coincident, a different output signal is produced than if the subimages do not fit together or are not coincident.

21. The method according to claim 20, which further comprises providing a data processing device to determine if the subimages fit together or are coincident in a course of a digital image processing method.

22. The method according to claim 20, which further comprises producing a digital signal or a binary signal as the output signal.

23. A device for producing a location signal, which indicates a location of a vehicle, including a track bound vehicle, the device comprising:
a range measurement device selected from the group consisting of a split-image range measurement device and a coincidence range measurement device, said range measurement device producing two subimages of an area around the vehicle on an output side;
a camera disposed downstream from said range measurement device for recording the subimages; and
a data processing device connected to said camera and configured such that it identifies a previously stored reference object in respectively recorded subimages in a course of image processing, and produces the location signal by evaluation of the subimages of a reference object.

24. The device according to claim 23, wherein said data processing device is configured such that said data processing device produces a range signal as the location signal, which indicates a range to the reference object, in that said data processing device first of all measures a distance to the reference object, forming a range measured value, in the course of a range measurement selected from the group consisting of a split-image range measurement and a coincidence range measurement, and outputs a respective range measured value with the location signal.

25. The device according to claim 24, wherein:
said range measurement device has an adjustment device, which can be controlled and adjusted by said data processing device; and
said data processing device is configured such that said data processing device adjusts said adjustment device until the subimages recorded by said camera fit one another or the subimages are coincident, and determines the range measured value on a basis of a setting of said adjustment device when the subimages fit together or are coincident.

26. The device according to claim 23, wherein said data processing device is configured such that said data processing device produces an output signal as the location signal, which indicates whether the reference object is or is not at a predetermined range, said data processing device uses said range measurement device, which has been preset to a predetermined range, to check whether the subimages fit together or the subimages recorded by said camera are coincident, and produces a different binary output signal if they fit together or are coincident than if they are not coincident.
